(19) United States
(12) Patent Application Publication
(10) Pub. No.: US 2013/0130086 A1
(43) Pub. Date: May 23, 2013

(54) ELECTRICAL ENERGY STORAGE DEVICE WITH FLAT STORAGE CELLS

(71) Applicant: Li-Tec Battery GmbH, Kamenz (DE)

(72) Inventor: Tim Schaefer, Harztor (DE)

(73) Assignee: LI-TEC BATTERY GMBH, Kamenz (DE)

(21) Appl. No.: 13/684,318

(22) Filed: Nov. 23, 2012

Related U.S. Application Data
(60) Provisional application No. 61/563,050, filed on Nov. 23, 2011.

(30) Foreign Application Priority Data
Nov. 23, 2011 (DE) 10 2011 119 212.7

(51) Int. Cl. H01M 2/20

(52) U.S. Cl. CPC H01M 2/202
USPC 429/120; 429/159

(57) ABSTRACT

In an electrical energy storage device with a plurality of flat storage cells for storing and delivering electrical energy having flat current conductors arranged at the narrow sides of the storage cells, and with a retaining apparatus for fastening the storage cells, at least one storage cell is fastened by the retaining apparatus at at least two, particularly opposite, narrow sides. In this arrangement the retaining apparatus exerts a tensile force on the storage cell that acts in the extension plane of the storage cell, by which the storage cell is tensioned. The retaining apparatus may also be equipped with a cooling device for cooling the storage cells, wherein the storage cells may particularly be cooled via their current conductors.

### CROSS-REFERENCE TO RELATED APPLICATIONS

This application claims the benefit of U.S. Provisional Patent Application Ser. No. 61/563,050, filed Nov. 23, 2011 and which is incorporated herein by reference in its entirety. This application also claims priority to German Patent Application No. 10 2011 119 212.7, filed Nov. 23, 2011 and which is incorporated herein by reference in its entirety.

### DESCRIPTION

The present invention relates to an electrical energy storage device comprising a plurality of flat storage cells.

The term electrical energy storage device is understood to mean a device for storing electrical energy, preferably chemically.

The electrical energy storage device comprises a plurality of storage cells, preferably rechargeable accumulator cells, particularly lithium ion cells. The storage cells are electrically connected to each other inside the electrical energy storage device, preferably in series or in parallel.

Such electrical energy storage devices are used for example to power electric or hybrid motor vehicles, but are also usable in stationary applications, as buffer batteries or as an emergency power supply, for example.

The storage cells under consideration are preferably flat storage cells, that is to say the storage cell extends essentially in one extension plane, and compared with its dimensions in the extension plane it has a relatively low height perpendicular to the extension plane.

In particular, prismatic storage cells are considered, that is to say the extension plane of the base surface of the storage cell is a polygon, particularly a rectangle, and its lateral edges, which particularly extend perpendicularly to the extension plane, are parallel and of equal length. In particular, cuboid storage cells are considered.

Many embodiments of such flat storage cells are known, particularly those having a rigid housing, for example with a metal frame, and those known as “pouch” or “coffee bag” cells, with a flexible casing, which is manufactured for example from a laminate of metal and plastic films.

Flat storage cells of the kind in question generally include an electrode arrangement in the interior thereof comprising electrode and interposed separator sheets arranged in layers one on top of the other. All positive or negative electrode sheets are connected individually with one or more current conductors, which pass out of the housing or casing of the storage cell to provide an electrical connection for charging and discharging the storage cell.

The current conductors of a storage cell are also of flat construction, for example in the form of flat metal plates or films, and preferably extend in the same extension plane as the storage cell. The current conductors are attached to the narrow sides of the storage cell, that is to say the lateral surfaces of the storage cell that are not parallel to the extension plane thereof.

The electrical energy storage device in question includes a plurality of such storage cells, in order to be able to store a correspondingly greater quantity of electrical energy and/or to supply a correspondingly greater electrical voltage.

Besides the storage cells themselves, the electrical energy storage device is equipped with a retaining apparatus for the storage cells, by which the storage cells are fastened and, in certain embodiments, are also kept at certain distances from each other. The electrical energy storage device may also comprise further components such as an electronic controller or a battery management system to enable controlled charging and discharging of the storage cells, measurement of cell parameters, for safety functions, for communication with external assemblies and the like.

One problem with the electrical energy storage devices of the kind in question is that the storage cells can generate considerable heat during charging and/or discharging, and this heat must be removed from the storage cells to avoid damaging them. The electrical energy storage device may therefore comprise a cooling device for the storage cells.

An electrical energy storage device of such kind having a cooling device is suggested for example in DE 10 2008 059 953 A1, in which the storage cells are pressed against a cooling plate, and at least one elastic element is provided for pressing each storage cell individually. In this arrangement, the storage cells are held together by a tension band and a tension plate.

The object of the present invention consists in providing an electrical energy storage device in which the storage cells may be installed simply and fastened mechanically securely.

The object is solved according to the invention by an electrical energy storage device as described in the preamble of claim 1, wherein the retaining apparatus fastens at least one storage cell at at least two, particularly opposite, narrow sides, and exerts a tensile force in the direction of the storage cell's extension plane, by which the storage cell is tensioned.

The tensile force exerted on the storage cell and the consequent mechanical tension under which the storage cell is placed provides a simple way of preventing each individual storage cell from shifting relative to the retaining apparatus, thus fastening it mechanically. At the same time, this type of retention does not require the storage cells to be in contact with each other in order for the retention to be effective, as is the case when the storage cells are held together by a tension band and/or a tension plate. Thus in the present arrangement the storage cells may be held in a fixed position and at the same time may be at a distance from one another. Particularly with flexible storage cells such as pouch cells, it would not be possible to fasten the cells by compressive force instead of the tensile force according to the invention, because the storage cells do not possess sufficient bending strength.

In a particularly preferred embodiment of the invention, the at least one storage cell is fastened at at least one narrow side at at least one current conductor.

The current conductor—particularly if it is constructed as a flat, metallic element—is suitable for the purpose of fastening due to its shape and resistance to tensile forces. Since the current conductor must be furnished anyway with an electrical contact for conducting the charging and discharging currents, the mechanical securing means and the electrical contact may preferably have the form of a single contact, thus simplifying the construction of the electrical energy storage device significantly.

Since the current conductor is generally permanently connected to the casing of the storage cell to seal the casing in fluid-tight manner, the tensile force according to the invention, which in this embodiment acts on the current conductor, is transferred onto the casing and is therefore not able to cause shifting, in particular pulling apart, of the electrode sheets that are connected to the current conductor or other components inside the storage cell, thereby damaging the storage cell.

In a further preferred embodiment of the invention, at least one storage cell is fastened at at least one of its narrow sides by a force-fit connection between the storage cell and the retaining apparatus. The force-fit connection is particularly preferably assured by terminals, particularly terminals of a current conductor, since the current conductor provides favourable conditions for a clamping connection of such kind, as was described in the preceding. A force-fit connection has the advantage that no special connecting devices have to be provided on the casing and/or the current conductors of the storage cell.

In a further preferred embodiment of the invention, at least one storage cell is fastened at at least one of its narrow sides with a form-fit connection between the storage cell and the storage device, preferably by hooking the storage cell into the retaining apparatus.

A form-fit connection has the advantage that the connection does not depend on a connecting force that must be applied permanently, and which may diminish for example as the connecting elements age. It is not subject to the risk either that the tensile force according to the invention that is applied to the storage cell will exceed the connecting force, and the connection between the storage cell and the retaining apparatus is broken unintentionally, provided the material of the storage cell has sufficient tear strength at the point where the form-fit connection with the retaining apparatus engages. However, this is certainly assured with the materials such as metals and plastics with high compressive strength that are usually used for storage cells.

A form-fit connection by hooking the storage cell into the retaining apparatus enables the electrical energy storage device to be assembled quickly and simply, and individual storage cells may be replaced just as easily if they malfunction.

In a further preferred embodiment of the invention, at least one storage cell is fastened at at least one of its narrow sides with an element of the retaining apparatus that passes through a through hole in the storage cell. This also creates a form-fit connection between the storage cell and the retaining apparatus. A through hole of such kind, preferably in a flat current conductor or a housing flange of the storage cell, may be created quickly and easily by punching, drilling or similar. Moreover, in this configuration only one element of the retaining apparatus, preferably an elongated element such as a bar, has to be provided to connect a plurality of storage cells to the retaining apparatus.

Of course, force-fit and form-fit connections—on different sides of the storage cells for example—may also be used in combination. The advantage of this is that, for example, when assembling the electrical energy storage device, the storage cells may first be fastened at a narrow side thereof by a form-fit connection, and thus be pre-assembled, before they are placed under tension by applying a tensile force according to the invention and then fastened under tension by a force-fit connection on another, opposite narrow side, thus being finally assembled.

In a further, particularly preferred embodiment of the invention, the retaining apparatus has at least one cooling apparatus for cooling the storage cells.

In one variant of this embodiment, the storage cells are cooled via at least one external cell wall of at least one storage cell, preferably by the flow of a cooling fluid over the external cell wall, preferably air or a liquid coolant. For this purpose, it is favourable if the individual storage cells are at a distance from each other inside the retaining apparatus, so that the cooling fluid is able to flow through the spaces between the storage cells and reach the largest possible areas of the external cell walls.

However, cooling of the storage cells via at least one external call wall may also take place statically, for example by inserting plates or mats made from a material with good heat conducting properties between adjacent storage cells, via which the heat is dissipated into the retaining apparatus and/or the environment.

In a further variant of this embodiment, the storage cells are cooled via at least one current conductor of at least one storage cell. In this way, the heat that is generated inside the storage cell may easily be conducted away to the outside even if part or all of the casing of the storage cell is made from a thermally insulating material fastened such as plastic.

In a further variant of this embodiment, the cooling device is equipped with a heat sink, particularly a heat sink with cooling fins. This enables the heat that is conducted away from the storage cells to be dissipated over a large surface area and into the environment.

Of course, several of the various cooling arrangements described may also be used in combination in an electrical energy storage device, for example, the storage cells may be cooled at the same time by a stream of coolant fluid and by conducting the heat away via the current conductors.

Further embodiments and advantages of the invention will now be explained with reference to the accompanying drawings, wherein:

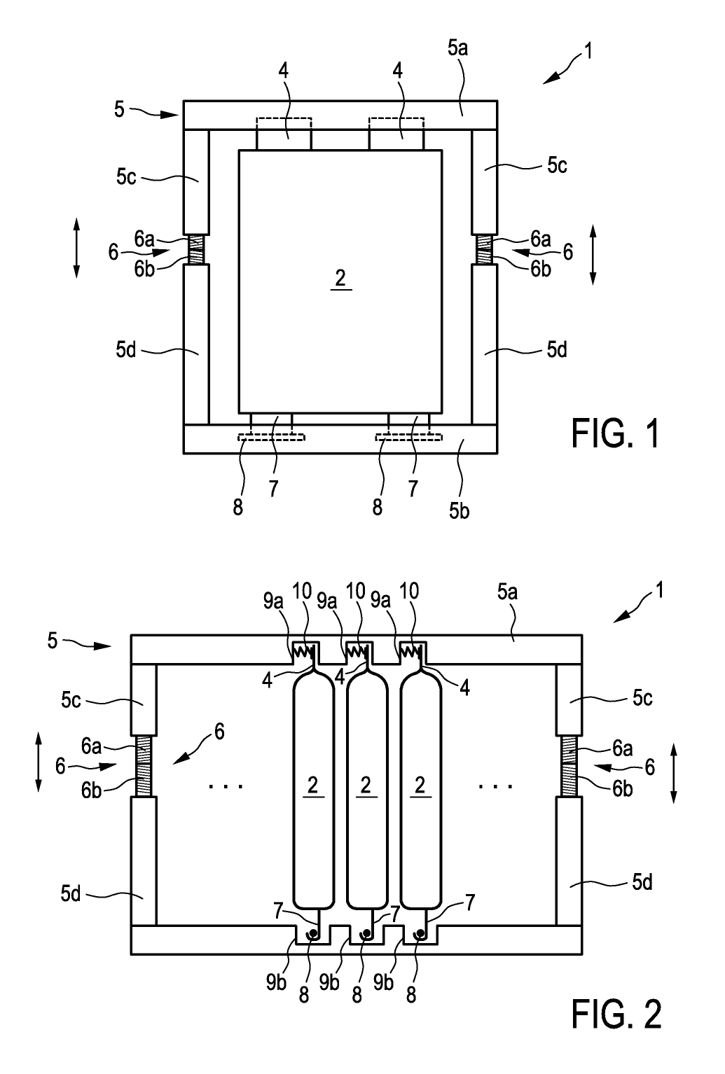

FIG. 1: is a front view of an electrical energy storage device according to the invention;

FIG. 2: is a side view of an electrical energy storage device according to the invention;

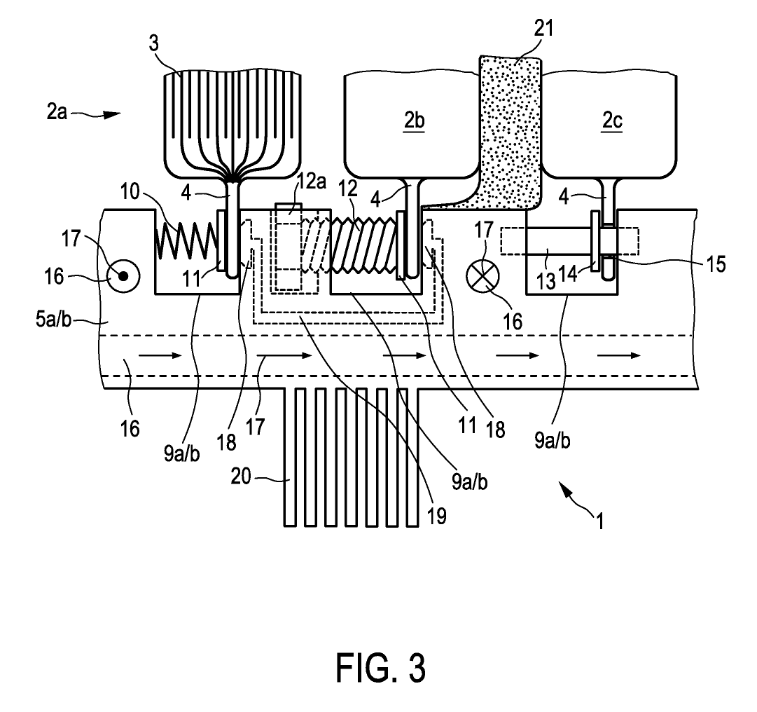

FIG. 3: shows a section of a retaining apparatus according to the invention with an exemplary representation of various fastening options for the storage cells and of other features of the electrical energy storage device.

The electrical energy storage device 1 according to the invention represented in a front view in FIG. 1 has a plurality of flat, rectangular storage cells 2, each of which has two current conductors 4 on the upper narrow side thereof and two retaining straps 7 on the lower narrow side thereof.

Electrical energy storage device 1 further comprises a cuboid retaining apparatus 5, wherein upper face 5a and lower face 5b of the cuboid are formed by solid, rigid plates, and the vertical edges that join upper and lower faces 5a and 5b are each formed by an upper strut 5c and a lower strut 5d, which are constructed correspondingly from solid, rigid bars.

In this context, in order to avoid short circuits when they contact storage cells 2, upper and lower faces 5a and 5b may be made from an electrically non-conductive material such as plastic, or also a plastic-sheathed metal, whereas upper and lower struts 5c and 5d may be made from metal.

Other components of electrical energy storage device 1, e.g. electrical or electronic ones, are not represented in the figures in order to preserve clarity.

The four upper and four lower struts 5c and 5d are arranged in pairs coaxially with each other, each pair being connected by a tensioning screw 6 that is located between upper strut 5c and lower strut 5d and is also arranged coaxially therewith. The upper half of tensioning screw 6 is furnished with a right-hand thread 6a and the lower half thereof is furnished with a left-hand thread 6b, both threads being external threads. The two external threads 6a and 6b engage with corresponding internal threads (not shown) in the lower frontal face of upper strut 5c and the upper frontal face of lower strut 5d.

When tensioning screw 6 is turned, the associated upper strut 5c and the associated lower strut 5d are moved apart coaxially. Accordingly, when all four tensioning screws 6 are turned together, upper face 5a and lower face 5b move apart parallel to one another. In this way, retaining apparatus 5 exerts a tensile force on storage cells 2, which are thus placed under tension in the vertical direction in their extension plane.

Storage cells 2 are fastened at upper face 5a at their conductors 4, the details of the fastening being illustrated in FIGS. 2 and 3. Storage cells 2 with their retaining straps 7 are also hooked onto hooking rods 8 at lower face 5b, the details of the hooking being illustrated in FIG. 2.

FIG. 2 is a representation of a side view of the electrical energy storage device 1 according to the invention. This shows that flat storage cells 2 are arranged in parallel with and at a distance from each other.

In order to fasten storage cells 2 on upper face 5a at their conductors 4, a continuous groove 9a is created for each storage cell 2 in the lower side of upper face 5a, parallel to the upper edge of the respective storage cell 2, and accommodates the two conductors 4. The two conductors 4 lie along one of the vertical side walls of groove 9a.

Each current conductor 4 is clamped and thus fastened inside groove 9a by a spring 10. Here, spring 10 is in the form of a compression spring with a relatively high spring constant to ensure that the conductors are fastened securely even against the tensile force of retaining apparatus 5.

The bottom end of each retaining strap 7 is bent through about 180° so that a hook extending over the full width of retaining strap 7 is created at the bottom end of retaining strap 7. With this hook, retaining strap 7 and therewith the entire storage cell 2 is hooked over a hooking rod 8 that is arranged in a groove 9b in lower face 5b and parallel to the alignment of the hook. In this way, the extension of groove 9b is mirror-symmetrical with that of corresponding groove 9a in upper face 5a. Hooking rod 8 is fastened to lower face 5b at its outer ends via suitable means. Instead of one continuous hooking rod 8, a separate hooking rod 8 may also be provided for each retaining strap 7, as shown in FIG. 1

In the embodiment represented in the drawings, retaining straps 7 have a purely mechanical securing function. Alternatively, however, current conductors 4 may also be constructed as retaining straps 7, in which case the current is then preferably conducted via hooking rods 8.

FIG. 3 shows a section of the upper or lower face 5a or 5b and illustrates exemplary representations of several options for fastening storage cells 2 at their current conductors 4 in grooves 9a or 9b in upper or lower face 5a or 5b, and various features of a cooling device for electrical energy storage device 1.

Regarding storage cell 2a, additionally the internal structure thereof is shown with positive and negative electrode sheets 3 being alternately stacked, wherein the, e.g. positive, electrode sheets 3, which are extended downwards, are joined and connected electrically to current conductor 4 via conductor tabs that are attached thereto.

As was already shown in FIG. 2, current conductor 4 of storage cell 2a is pressed against an interior wall of groove 9a/b by a compression spring 10 (some components that are also arranged flush with each other are shown with a small space between them in FIG. 3 for better visibility). FIG. 3 also shows that a clamping plate 11 is arranged at the end of spring 10 that contacts current conductor 4 in order to create a secure mechanical contact.

In contrast to this, with regard to storage cell 2b, current conductor 4 is pressed against an interior wall of groove 9a/b by a clamping screw 12. Clamping screw 12 is guided in an internally threaded insert in the opposite side wall of groove 9a/b and is tightened via a hexagon head screw 12a that is accessible through a cutaway in the web between groove 9a/b and the adjacent groove. The end of clamping screw 12 that contacts current conductor 4 is also furnished with a clamping plate 11.

In the case of storage cell 2c, fastening in groove 9a/b is assured in form-fit manner by a locking pin 13 that passes through a through hole 15 in current conductor 4 and is supported at both ends in the opposing side walls of groove 9a/b. A flange 14 mounted on locking pin 13 prevents current conductor 4 and therewith also storage cell 2 from slipping axially on locking pin 13.

This form-fit connection yields a particularly secure means of fastening storage cell 2c at retaining apparatus 5, which is advantageous for example if electrical energy storage device 1 is moved or vibrates, for example.

Finally, FIG. 3 also illustrates various options for a cooling device for an electrical energy storage device 1 according to the invention.

Firstly, cooling channels 16 may extend in upper and lower faces 5a and/or 5b parallel or perpendicularly to grooves 9a/b. Here, the direction of flow of the coolant is indicated by corresponding arrows or symbols in the cross section of cooling channels 16. The individual cooling channels 16 may be connected to form a continuous cooling coil in a zigzag pattern for example.

Additionally, the upper or lower face 5a or 5b may be furnished with a heat sink having cooling fins 20 that increase the surface area of face 5a or 5b and thus ensure that the heat extracted from storage cells 2 is conducted away to the outside atmosphere more quickly.

Finally, flat, plate-like inserts made from a material with good thermal conductivity, for example foam rubber pads 21, arranged between storage cells 2, preferably clamped and/or glued to storage cells 2 with a thermally conductive adhesive, also serve the cooling of storage cells 2.

Foam rubber pads 21 fill the spaces between storage cells 2, which are arranged at a distance from each other, and besides cooling also serve as an additional means for fastening storage cells 2, particularly for preventing storage cells 2 from moving perpendicularly with respect to their extension plane. In this way, foam rubber pads 21 also have a particularly shock-absorbing effect for storage cells 2.

The frontal faces of foam rubber pads 21 are also glued with thermally conductive adhesive to the web between grooves 9a/b in the upper face 5a and/or lower face 5b to conduct the heat extracted from storage cells 2 away to retaining apparatus 5 and thus to the environment.

Cooling channels 16 may also be provided inside or on foam rubber pads 21 to improve cooling efficiency. In addition, at least one temperature sensor may be arranged in foam rubber pads 21 and may serve to measure the temperature of the adjacent storage cells 2 and/or of the coolant fluid that flows through the respective cooling channel 16.

Contact surfaces 18, which are sunk into upper face 5a and/or lower face 5b and are connected via an electrical conductor 19 assure the electrical contact for current conductors 4. Contact surfaces 18 are arranged such that they touch and electrically contact the current conductors 4 that are pressed against the side walls of grooves 9a/b.

Alternatively, the fastening elements for current conductors 4 such as spring 10, clamping screw 12, clamping plate 11 or locking pin 13 may also be used themselves to provide the electrical contact for current conductors 4.

In FIG. 3, current conductors 4 of storage cells 2a and 2b are connected to one another electrically via contact surfaces 18 and electrical conductor 19 for exemplary purposes. In this way, for example, it is simple to create series and/or parallel connections for storage cells 2.

### LEGEND

1 Electrical energy storage device
2, 2a, 2b, 2c Storage cell
3 Electrode sheets
4 Current conductor
5 Retaining apparatus
5a Upper face
5b Lower face
5c Upper strut
5d Lower strut
6 Tensioning screw
6a Right-hand thread
6b Left-hand thread
7 Retaining strap
8 Hooking rod
9a, 9b Groove
10 Spring
11 Clamping plate
12 Clamping screw
12a Hexagon head screw
13 Locking pin
14 Flange
15 Through hole
16 Cooling channel
17 Direction of flow of the coolant
18 Contact surface
19 Electrical conductor
20 Cooling fin
21 Foam rubber pad

1. An electrical energy storage device comprising:
a plurality of flat storage cells for storing and delivering electrical energy,
flat current conductors arranged at the narrow sides of the storage cells, and having
a retaining apparatus for fastening the storage cells, wherein the retaining apparatus fastens at least one storage cell at at least two, particularly opposite, narrow sides, and exerts a tensile force on the storage cell in the direction of the extension plane of the storage cell, by which the storage cell is tensioned.

2. The electrical energy storage device according to claim 1, wherein the fastening is done at at least one narrow side at at least one current conductor of the at least one storage cell.

3. The electrical energy storage device according to claim 1, wherein the fastening is done at at least one narrow side of the storage cell by a force-fit connection of the at least one storage cell with the retaining apparatus.

4. The electrical energy storage device according to claim 3, wherein the fastening is done at at least one narrow side of the at least one storage cell by clamping, particularly by clamping a current conductor.

5. The electrical energy storage device according to claim 1, wherein the fastening is done at at least one narrow side of the at least one storage cell by a form-fit connection of the storage cell with the retaining apparatus.

6. The electrical energy storage device according to claim 5, wherein the fastening is done at at least one narrow side of the at least one storage cell by hooking the storage cell into the retaining apparatus.

7. The electrical energy storage device according to claim 5, wherein the fastening is done at at least one narrow side of the at least one storage cell by an element of the retaining apparatus passing through a through hole in the storage cell.

8. The electrical energy storage device according to claim 1, wherein the retaining apparatus has at least one cooling device for cooling at least one storage cell.

9. The electrical energy storage device according to claim 8, wherein the cooling of the at least one storage cell is done via at least one external cell wall of the storage cell.

10. The electrical energy storage device according to claim 8, wherein the cooling of the at least one storage cell is done via at least one current conductor of the storage cell.

11. The electrical energy storage device according to claim 1, wherein the cooling device has a heat sink, particularly a heat sink with cooling fins.

12. The electrical energy storage device according to claim 8, wherein the cooling device has a cooling channel through which a coolant fluid flows.
